(19) United States
(12) Patent Application Publication
(10) Pub. No.: US 2010/0222991 A1
(43) Pub. Date: Sep. 2, 2010

(54) METHOD FOR OPERATING AN INTERNAL COMBUSTION ENGINE

(75) Inventor: Tobias Maria Berr, Stuttgart (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Stuttgart (DE)

(21) Appl. No.: 12/706,897

(22) Filed: Feb. 17, 2010

(30) Foreign Application Priority Data
Mar. 2, 2009 (DE) 10 2009 011 281.2

(51) Int. Cl. F02D 45/00

(52) U.S. Cl. 701/112

(57) ABSTRACT

In a method for operating an internal combustion engine in a motor vehicle, the internal combustion engine can be operated with a start/stop system. The motor vehicle has a brake booster which generates an assisting force for assisting a braking force, wherein the brake booster is supplied by an under-pressure in an air inlet pipe of the internal combustion engine. In this context, it is detected when the pressure in the brake booster exceeds a threshold value which is determined in an open-loop and/or closed-loop control device.

### CROSS-REFERENCE TO RELATED APPLICATION

This application claims the priority, under 35 U.S.C. §119, of German application DE 10 2009 011 281.2, filed Mar. 2, 2009; the prior application is herewith incorporated by reference in its entirety.

### BACKGROUND OF THE INVENTION

### Field of the Invention

The invention relates to a method for operating an internal combustion engine in a motor vehicle, wherein the internal combustion engine can be operated with a start/stop system. The motor vehicle has here a brake booster which generates an assisting force for assisting a braking force, wherein the brake booster can be supplied by an under-pressure in an air inlet pipe of the internal combustion engine. Alternatively, the required under-pressure can also be made available by an under-pressure pump which is driven indirectly or directly by the crankshaft of the internal combustion engine. Such mechanical under-pressure pumps are used especially in vehicles whose internal combustion engines operate according to the diesel method. The method according to the invention can be used for both types of under-pressure systems. Furthermore, part of the invention is an open-loop and/or closed-loop control device and a computer program.

In order to reduce fuel consumption and emissions of pollutants, methods and systems are developed which automatically switch off the drive unit of a motor vehicle under certain conditions and/or when predefined switch-off conditions are met, and switch it on again automatically when predefined switch-on conditions are met. Such methods and systems or start/stop devices are especially suitable for reducing fuel consumption and emissions in city traffic. In the known start/stop system, pressing on a brake pedal for a relatively long time is sufficient, and the drive unit stops automatically. After the stop, it is sufficient, for example, merely to touch an accelerator pedal and the drive unit starts again automatically.

Whenever the brake pedal is activated, the under-pressure in an accumulator of the brake system is reduced. Therefore, after repeated activation of the brake pedal when the internal combustion engine is switched off the pressure accumulator may empty to such an extent that the function of the brake booster is adversely affected.

The lack of brake boosting can constitute a considerable safety risk for the vehicle occupants.

### SUMMARY OF THE INVENTION

It is accordingly an object of the invention to provide a method for operating an internal combustion engine which overcomes the above-mentioned disadvantages of the prior art methods of this general type, in which improved travel is accomplished with a motor vehicle having an integrated start/stop system in terms of comfort and safety.

With the foregoing and other objects in view there is provided, in accordance with the invention a method for operating an internal combustion engine in a motor vehicle. The internal combustion engine is operated with a start/stop system. The motor vehicle has a brake booster generating an assisting force for assisting a braking force, and the brake booster is supplied by an under-pressure in an air inlet pipe of the internal combustion engine. The method includes the step of detecting when a pressure in the brake booster exceeds a threshold value which is determined in an open and/or closed-control device.

The object is achieved by a method for operating an internal combustion engine in which it is detected when the pressure in the brake booster exceeds a threshold value which is determined in an open-loop and/or closed-loop control device.

According to the invention, the currently determined pressure in the brake booster is compared with the threshold value. The pressure in the brake booster can be determined, for example, by a pressure sensor whose signal is subsequently evaluated in an open-loop and/or closed-loop control device. Corresponding, regulating measures for the brake booster can then be taken in the open-loop and/or closed-loop control device. As a result, especially the safety of the vehicle and of the driver are considerably improved.

By testing it is possible to determine a critical under-pressure in the pressure accumulator of the brake booster, which under-pressure reduces the boosting effect of the brake booster in such a way that, on the one hand, there are considerable safety deficiencies for the motor vehicle and the driver thereof and, on the other hand, restoring the necessary under-pressure would take an inappropriately long time. When the pressure level is virtually equalized, the build up of under-pressure can take up to 20 seconds after the internal combustion engine starts, which is no longer acceptable for reasons of safety. In this time period, only reduced braking force assistance would be available to the driver. The critical under-pressure which is determined in such a way can be used as a threshold value in the method according to the invention.

Features which are important for the invention can also be found in the following description and in the drawing, and in this context the features may be important for the invention either in isolation or in different combinations, without explicit details being given on this.

For the method it is significant that the threshold value is dependent on a geodetic height at which the motor vehicle is travelling and/or a current ambient air pressure. Ultimately, a difference between the current pressure in the brake booster and the ambient air pressure is decisive for the brake-boosting effect in the brake booster. Since the ambient air pressure (referred to below as air pressure) depends on the geodetic height, it is appropriate to adapt the threshold value determined in the laboratory to the geodetic height and to the atmospheric air pressure prevailing there. The current geodetic height may be determined, for example, by a navigation device of the motor vehicle. The geodetic height is then converted into an atmospheric air pressure in the open-loop and/or closed-loop control device. This may be done, for example, by a characteristic curve which is implemented in the open-loop and/or closed-loop control device. Alternatively, the atmospheric pressure can also be determined by an ambient pressure sensor. The air pressure data can subsequently be evaluated in the open-loop and/or closed-loop control device and the data can correspondingly adapt the threshold value determined in the laboratory. The determination of the atmospheric air pressure does not require any additional hardware since devices are used which are generally already present in the motor vehicle.

For the method it is also significant that the threshold value is dependent on an ambient temperature at which the motor vehicle is travelling. In this context it is taken into account that the pressure is basically dependent on the temperature. The ambient temperature may, for example, easily be determined by a temperature sensor, with the signal of the temperature sensor being evaluated in the open-loop and/or closed-loop control device. After this, the threshold value which is determined in the laboratory can be adapted in accordance with the temperature which is determined. The determination of the temperature and the subsequent adaptation of the pressure are effective and inexpensive.

It is particularly advantageous that the internal combustion engine is started automatically or automatic stopping of the internal combustion engine is blocked if the under-pressure in the pressure accumulator of the brake system is above the threshold value. As a result of the automatic starting, under-pressure is generated again in the intake manifold of the internal combustion engine or in the under-pressure pump and is fed to the brake booster. As a result, the function of the brake booster is restored. If it is detected, in the stationary state of the vehicle, that the pressure exceeds the first threshold value which has been determined, the automatic stop function is blocked; the internal combustion engine therefore carries on running, with the result that the under-pressure in the pressure accumulator is reduced further. The automatic stop function of the internal combustion engine is also blocked for safety reasons if a diagnostic program detects a fault. These measures boost the objective and subjective sensitivity of the driver toward increased comfort and safety.

In a further advantageous refinement of the method according to the invention, when the vehicle is stationary the internal combustion engine is not deactivated until the under-pressure in the pressure accumulator drops below a second threshold value. The second threshold value is below the first threshold value.

It is also possible here that an optical and/or acoustic signal is emitted for a driver of the motor vehicle when there is an automatically initiated start on the basis of the pressure in the brake booster exceeding the threshold value. The signal can, for example, be indicated on a dashboard of the motor vehicle or transmitted. This measure also increases the subjective sensitivity of the driver toward increased comfort and also confirms technical competence on the part of the motor vehicle manufacturer.

Other features which are considered as characteristic for the invention are set forth in the appended claims.

Although the invention is illustrated and described herein as embodied in a method for operating an internal combustion engine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of an internal combustion engine; and

FIG. 2 is a flowchart for explaining a method according to the invention.

### DETAILED DESCRIPTION OF THE INVENTION

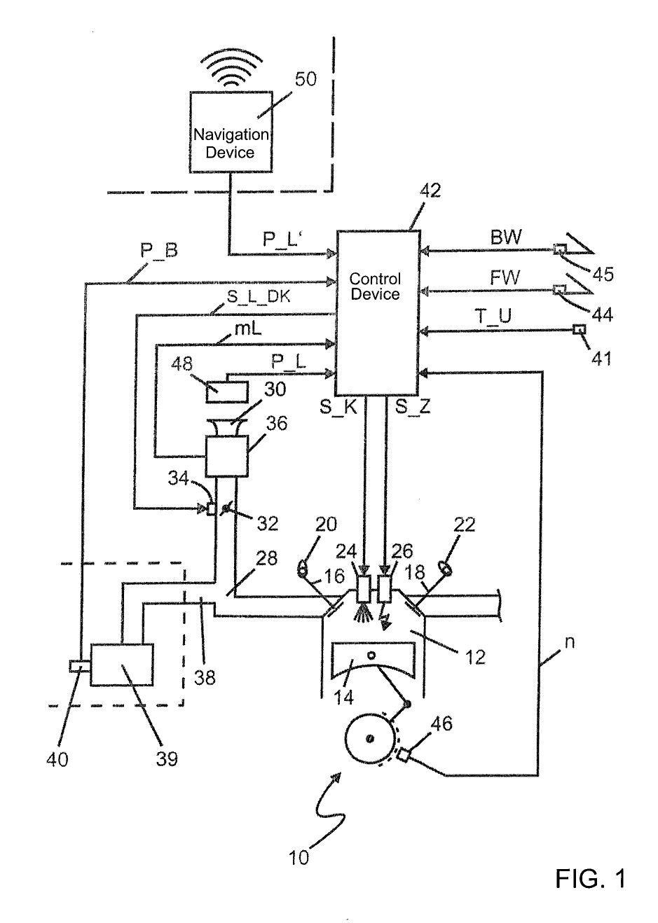

Referring now to the figures of the drawing in detail and first, particularly, to FIG. 1 thereof, there is shown the technical field of the invention. In particular, FIG. 1 shows an internal combustion engine 10 with a combustion chamber 12 which is sealed off in a movable fashion by a piston 14. A change of the charges of the combustion chamber 12 is controlled by at least one inlet valve 16 and an outlet valve 18, which are actuated for this purpose by corresponding actuators 20, 22. In the embodiment in FIG. 1, an injector 24 is used to meter fuel into an air charge of the combustion chamber 22. The resulting mixture of fuel and air is ignited by a spark plug 26. The combustion chamber 12 is charged with air from an intake manifold 28 with an intake connector 30. The intake manifold 28 has a throttle valve 32 which is actuated by a throttle valve actuator 34, and an air mass flow rate meter 36. A connecting line 38 branches off from the intake manifold 28 and leads to a pressure accumulator of a brake booster 39 of the motor vehicle. As an alternative to the illustrated exemplary embodiment, the brake booster 39 can also be supplied with under-pressure by a non-illustrated mechanical under-pressure pump. In order to determine a pressure in the brake booster 39, the brake booster 39 contains a pressure sensor 40 which transmits the current pressure information to an open-loop and closed-loop control device 42. Furthermore, the internal combustion engine 10 has a temperature sensor 41 which determines an ambient temperature.

The internal combustion engine 10 is controlled by the open-loop and closed-loop control device 42 which, for this purpose, processes signals in which various operating parameters of the internal combustion engine 10 are mapped. In the illustration in FIG. 1, these are especially a signal mL of the air mass flow rate meter 36, a signal FW of a driver's request signal generator 44 which senses a torque request of the driver, a signal BW of a brake pedal signal generator 45, a signal n of a rotational speed signal generator 46 which senses a rotational speed n of a crankshaft of the internal combustion engine 10, a signal P_L of an ambient pressure sensor 48, an ambient temperature T_U of the temperature sensor 41 and a pressure signal P_B of the pressure sensor 40. The ambient pressure sensor 48 is arranged in the region of the intake connector 30.

Of course, modern internal combustion engines 10 are equipped with multiple further signal generators and/or sensors which are not illustrated here for reasons of clarity. Examples of such sensors are further temperature sensors and pressure sensors, exhaust gas sensors etcetera. The enumeration of the signal generators 36, 40, 41, 44, 46 and 48 is not intended to be conclusive in this regard. A separate sensor also need not be provided for each operating parameter processed by the open-loop and closed-loop control device 42 because the open-loop and closed-loop control device 42 can model various operating parameters from other, measured operating parameters using computational models.

The open-loop and closed-loop control device 42 forms, inter alia, manipulated variables from the received signal generator signals in order to set the torque which is to be generated by the internal combustion engine 10. In the embodiment in FIG. 1, these are, in particular, a manipulated variable S_K for actuating the injector 24, a manipulated variable S_Z for actuating the spark plug 26 and a manipulated variable S_L_DK for actuating the throttle valve actuator 34. Furthermore, FIG. 1 shows a navigation device 50 which is arranged outside the vicinity of the internal combustion engine 10. The navigation device 50 is connected to the open-loop and closed-loop control device 42 via a signal line.

The internal combustion engine 10 is, as is apparent from FIG. 1, coupled to an under-pressure pump 48 and drives the latter. The under-pressure pump 48 serves to make available the auxiliary energy necessary for the brake booster 39 in the form of under-pressure. The rest of the brake system is not illustrated for reasons of clarity.

The open-loop and closed-loop control device 42 is moreover configured, in particular programmed, to carry out the method according to the invention or one of its embodiments and/or to control the corresponding method sequence.

The internal combustion engine 10 can be operated with a start/stop system. The depression of a non-illustrated brake pedal in order to stop the internal combustion engine 10 within the operation of the start/stop system—and particularly subsequent repeated depression of the brake pedal when the internal combustion engine 10 is switched off—has the effect of equalizing the under-pressure in the brake booster 39 with an atmospheric air pressure, and of therefore significantly reducing the brake-boosting effect of the brake booster 39. When the internal combustion engine 10 is switched off, no under-pressure is generated in the intake manifold 28 of the internal combustion engine 10, as a result of which the brake booster 39 which is connected to the inlet manifold 28 and to the connecting pipe 38 can also no longer be supplied with under-pressure. In the method according to the invention, the open-loop and closed-loop control device 42 evaluates the pressure information P_B in the brake booster 39 and takes corresponding regulating measures for the operation of the brake booster 39.

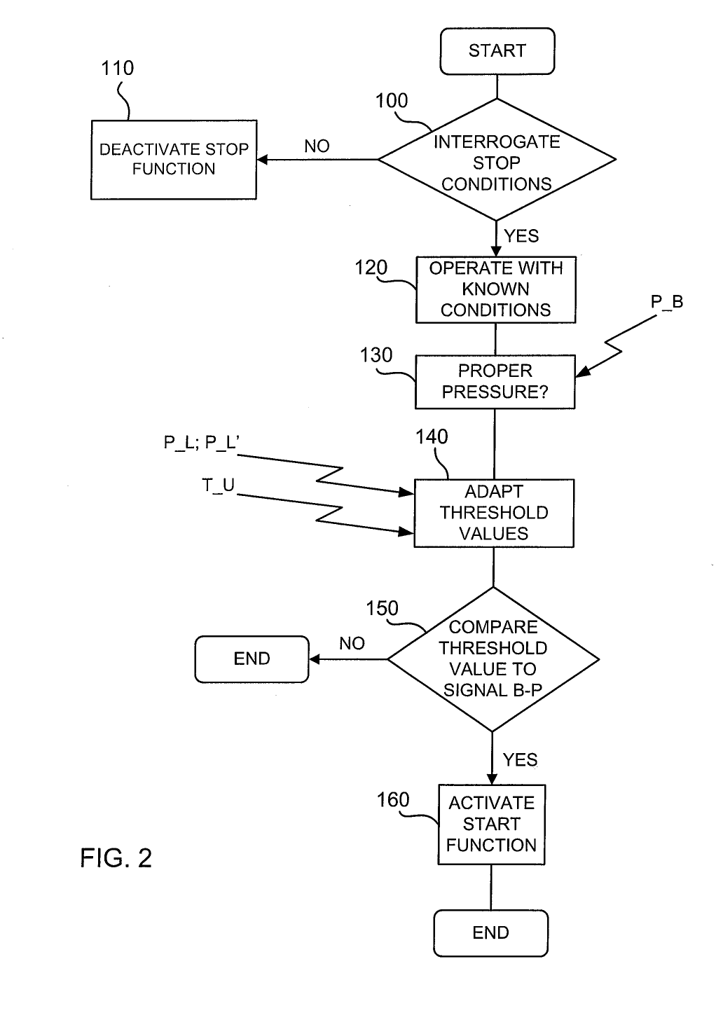

FIG. 2 shows a flowchart with the method according to the invention. In order to start the method, the motor vehicle is in the stationary mode. The internal combustion engine 10 is in operation and the brake pedal in the vehicle is depressed. In step 100, general stop conditions for the operation of the internal combustion engine 10 are interrogated from the open-loop and closed-loop control device 42. General stop conditions are met, for example, if the internal combustion engine 10 is cold or if faulty sensors have been detected by on-board diagnostics. Further stop conditions are possible. If one of these general stop conditions is met, the stop function of the internal combustion engine 10 is deactivated (step 110), i.e. the internal combustion engine 10 continues running despite the vehicle being in a stationary state even if the brake pedal is activated. If none of these general stop conditions are met, the internal combustion engine 10 is operated with the known start/stop system (step 120) and the internal combustion engine 10 stops if the brake pedal is activated during the stationary state of the vehicle.

According to the invention, in this operating state the open-loop and closed-loop control device 42 determines whether the pressure in the brake booster 39 drops (step 130) as a result of, for example, repeated depression of the brake pedal. For this purpose, the signal P_B of the pressure sensor 40 is evaluated.

In step 140, the signal T_U of the temperature sensor 41, the signal P_L of the ambient pressure sensor 48 or the signal P_L′ of the navigation device 50 is fed to the open-loop and closed-loop control device 42 via signal lines. When the navigation device 50 is used, the open-loop and closed-loop control device 42 determines a current air pressure from a current geodetic height (signal P_L′). The information of the signal P_L and of the converted signal P_L′ are then considered to be equivalent, with the further processing of a signal being sufficient in the specific implementation.

The information of the signals T_U, P_L or P_L′ influences a first threshold value which is predefined in the open-loop and closed-loop control device 42 and which defines a critical pressure in the brake booster 39 at which the pressure in the brake booster 39 has risen in such a way that the brake booster 39 only operates with a reduced braking power. In step 140, the threshold value which is determined in the laboratory is adapted by the information of the signals T_U, P_L or P_L′.

In step 150, the adapted threshold value is then compared with the information of the signal P_B from the pressure sensor 40, and diagnostics and plausibility checking are performed on it. If the result of the diagnostics by the open-loop and closed-loop control device 42 is that the current pressure in the brake booster 39 is above the adapted threshold value, the automatic starting function of the internal combustion engine 10 is activated in step 160. As a result, the under-pressure in the brake booster 39 is restored, and the correct functioning of the brake booster is ensured again. If the currently determined pressure in the brake booster 39 is in the permitted region, the normal start/stop operation is continued.

1. A method for operating an internal combustion engine in a motor vehicle, the internal combustion engine being operated with a start/stop system, the motor vehicle having a brake booster generating an assisting force for assisting a braking force, and the brake booster is supplied by an under-pressure in an air inlet pipe of the internal combustion engine, which comprises the step of:
detecting when a pressure in the brake booster exceeds a threshold value which is determined in an open and/or closed-control device.

2. The method according to claim 1, wherein the threshold value is dependent on at least one of a geodetic height at which the motor vehicle is travelling and a current atmospheric air pressure.

3. The method according to claim 1, wherein the threshold value is dependent on an ambient temperature at which the motor vehicle is travelling.

4. The method according to claim 1, which further comprises starting the internal combustion engine automatically if the under-pressure in the brake booster exceeds the threshold value.

5. The method according to claim 1, which further comprises blocking an automatic stopping of the internal combustion engine if the under-pressure in the brake booster exceeds the threshold value.

6. The method according to claim 5, which further comprises switching off the internal combustion engine if the under-pressure in the brake booster drops below a further threshold value.

7. The method according to claim 6, which further comprises setting the further threshold value to be lower than the threshold value.

8. The method according to claim 1, which further comprises emitting a signal selected from the group consisting of a visual signal, an acoustic signal, and an acoustic and visual signal for a driver of the motor vehicle if automatically initiated starting of the internal combustion engine occurs because the under-pressure in the brake booster exceeds the threshold value.

9. An open-loop and/or closed-loop control device for an internal combustion engine, comprising:
a control device programmed to detect when a pressure in a brake booster exceeds a threshold value which is determined by said control device.

10. A computer-readable medium having computer-executable instructions for performing a method for operating an internal combustion engine in a motor vehicle, the internal combustion engine being operated with a start/stop system, the motor vehicle having a brake booster generating an assisting force for assisting a braking force, and the brake booster is supplied by an under-pressure in an air inlet pipe of the internal combustion engine, which comprises the step of:
detecting when a pressure in the brake booster exceeds a threshold value which is determined in an open and/or closed-control device.

11. An open-loop and closed-loop control device, comprising:
a control device programmed to detect when a pressure in the brake booster exceeds a threshold value which is determined by said control device.
